(19) United States
(12) Patent Application Publication
(10) Pub. No.: US 2013/0020498 A1
(43) Pub. Date: Jan. 24, 2013

(54) FLOW CYTOMETER

(71) Applicants: Ryuichiro Ebi, Osaka-shi (JP); Koki Tajima, Kobe-shi (JP); Tsohikuni Suganuma, Kobe-shi (JP)

(72) Inventors: Ryuichiro Ebi, Osaka-shi (JP); Koki Tajima, Kobe-shi (JP); Tsohikuni Suganuma, Kobe-shi (JP)

(73) Assignee: SYSMEX CORPORATION, Kobe-shi (JP)

(21) Appl. No.: 13/552,029

(22) Filed: Jul. 18, 2012

(30) Foreign Application Priority Data
Jul. 19, 2011 (JP) 2011-157638

(51) Int. Cl. G01N 21/47; G01N 21/64

(52) U.S. Cl. 250/435; 356/337

(57) ABSTRACT

A flow cytometer is provided comprising a sample nozzle, a flow cell with a first flow pass arranged downstream from the sample nozzle, a sample nozzle receiver with a second flow pass, with a sample nozzle arranged within the second flow pass, a measurement sample supplier, and a sheath fluid supplier, wherein at least a part of the sample nozzle receiver comprises a tapered part for narrowing the second flow pass in the direction toward the first flow pass and the tapered part has a first tapered part with an aspect ratio that is larger than 1 in the transverse section of the flow pass interesting to the flow direction of the measurement sample, and the end on the downstream side of the sample nozzle is arranged at the first tapered part of the tapered part.

### FIELD OF THE INVENTION

The present invention relates to a flow cytometer, and more specifically related to a flow cytometer with as flow cell through which the substance being measured passes.

### BACKGROUND

Conventional flow cytometers are known to have a flow cell through which the substance being measured passes. Specifically, there are known flow cytometers that capture an image of a measurement object such as cell or particles as the measurement object flows through a flow cell, and flow cytometers that detect the light irradiated from a measurement object flowing through a flow cell. Analysis of the measurement object is performed by analyzing the captured image or the optical information obtained from the measurement object. When the measurement object has an asymmetrical flat shape, such flow cytometers must fix the direction (fix the orientation) of the measurement object as it flows through the flow cell in accordance with the image capture direction or the direction of the illuminating light in order to obtain high accuracy analysis results. Therefore, conventional flow cytometers are known to have a structure to fix the direction (fix the orientation) of the measurement object (for example, refer to U.S. Pat. No. 4,988,619, and Yoshio Tenjin, Manabu Takahashi, Kazuhiro Nomura, eds., “Flow Cytometry Handbook,” Science Forum, Inc., published Nov. 30, 1984, pages 398-403. Hereinafter referred to as “Tenjin”).

The flow cytometer disclosed in U.S. Pat. No. 4,988,619 fixes the orientation of the measurement object by dividing the sheath fluid using a fin or cylindrical rod, and producing a confluence of flows to constrict the sheath flow of the divided measurement object near the outlet of the sample nozzle (test nozzle) that supplies the measurement object.

Tenjin et al. disclosed a technique for fixing the orientation of cells in a process that constricts the flow of cells suspended in a liquid encapsulated by the sheath fluid. Specifically, the disclosure states that the cell orientation is fixed by using a nozzle with a rectangular cross section having different ratios of constriction vertically and horizontally, or a nozzle with a cross section that constricts from circular to elliptical, and using the rotational moment on the cell flowing through the nozzle. Tenjin et al. further disclosed fixing the orientation of cells at the stage the cell suspension is encapsulated in the sheath fluid at the outlet of the sample nozzle by forming the leading edge of the sample nozzle in a wedge shape.

The flow cytometer disclosed in U.S. Pat. No. 4,988,619 has a problem of causing turbulence in the flow of the sheath fluid and the flow of the measurement object encapsulated in the sheath fluid due to the division and confluence of the sheath fluid. Turbulence generated in the flow of the measurement object will induce variation in the orientation of the measurement object and reduce the analysis accuracy of the measurement object. On the other hand, in the techniques disclosed by Tenjin et al., it is difficult to orient the measurement object to a sufficient percentage since ells of various shapes are included when, for example, measuring epithelial cells collected from a patient. Therefore, it is desirable to be able to fix the orientation of the measurement object to a high percentage (improve the orientation ratio of the measurement object).

### SUMMARY OF THE INVENTION

The scope of the present invention is defined solely by the appended claims, and is not affected to any degree by the statements within this summary.

The present invention aims to solve these problems. An object of the present invention is to provide a flow cytometer capable of improving the orientation ratio of the measurement object.

A first aspect of the present invention is a flow cytometer, comprising:

a sample nozzle for passing a measurement sample containing a measurement object;

a flow cell with an interior first flow pass, the flow cell being arranged downstream from the sample nozzle;

a sample nozzle receiving section with an interior second flow pass that communicates with the first flow pass and has a larger internal diameter than the exterior diameter of the sample nozzle, configured to hold the sample nozzle within the second flow pass;

a measurement sample supplying section for supplying a measurement sample to the sample nozzle; and

a sheath fluid supplying section for supplying sheath fluid to the second flow pass of the sample nozzle receiving section; wherein

the sample nozzle receiving section comprises at least in part a tapered part for narrowing the second flow pass toward the first flow pass;

the tapered part has a first tapered part with an aspect ratio larger than 1 of the transverse section of the flow pass intersecting the flow direction of the measurement sample; and

the end on the downstream side of the sample nozzle is arranged at the first tapered part of the tapered part.

A second aspect of the present invention is an analyzer, comprising:

a detection section for detecting a measurement object in a measurement sample; and

a controller configured for performing operations, comprising: outputting based on the detection result of the detection section; wherein

the detection section comprises

a flow cytometer, comprising:

a sample nozzle for passing a measurement sample containing a measurement object;

a flow cell with an interior first flow pass, the flow cell being arranged downstream from the sample nozzle;

a sample nozzle receiving section with an interior second flow pass that communicates with the first flow pass and has a larger internal diameter than the exterior diameter of the sample nozzle, configured to hold the sample nozzle within the second flow pass;

a measurement sample supplying section for supplying a measurement sample to the sample nozzle; and

a sheath fluid supplying section for supplying sheath fluid to the second flow pass of the sample nozzle receiving section; wherein

the sample nozzle receiving section comprises at least in part a tapered part for narrowing the second flow pass toward the first flow pass;

the tapered part has a first tapered part with an aspect ratio larger than 1 of the transverse section of the flow pass intersecting the flow direction of the measurement sample; and

the end on the downstream side of the sample nozzle is arranged at the first tapered part of the tapered part.

### BRIEF DESCRIPTION OF THE DRAWINGS

FIG. 1 is a perspective view showing the general structure of a cell analyzer using a detecting unit of an embodiment of the present invention;

FIG. 2 is a block diagram showing the structure of the measuring device of the cell analyzer shown in FIG. 1;

FIG. 3 is a block diagram showing the structure of the detecting unit of an embodiment of the present invention;

FIG. 4 is a vertical cross sectional view showing the structure of the flow cell unit of the detecting unit shown in FIG. 3;

FIG. 5 is a perspective view of the test nozzle of the flow cell unit shown in FIG. 4;

FIG. 6 is a side view of the peripheral end on the downstream side of the test nozzle shown in FIG. 5;

FIG. 7 is a plan view of the peripheral end on the downstream side of the test nozzle shown in FIG. 5;

FIG. 8 is a perspective view illustrating the structure of the test nozzle receptacle of the flow cell unit shown in FIG. 4;

FIG. 9 is a transverse sectional view of the test nozzle receptacle (second flow pass) along the 101-101 line of FIG. 4;

FIG. 10 is a transverse sectional view of the test nozzle receptacle (second flow pass) along the 102-102 line of FIG. 4;

FIG. 11 is a transverse sectional view of the test nozzle receptacle (second flow pass) along the 103-103 line of FIG. 4;

FIG. 12 is a transverse sectional view of the test nozzle receptacle (second flow pass) along the 104-104 line of FIG. 4;

FIG. 13 is a transverse sectional view of the test nozzle receptacle (second flow pass) along the 105-105 line of FIG. 4;

FIG. 14 is an enlargement of the transverse sectional view shown in FIG. 13;

FIG. 15 illustrates the signal waveform when laser light is irradiated from the front surface side of the flat epithelial cell;

FIG. 16 illustrates the signal waveform when laser light is irradiated from the side surface side of the flat epithelial cell;

FIG. 17 is a perspective view showing the internal structure of the flow cell unit of the first embodiment of the present invention;

FIG. 18 is a perspective view showing the internal structure of the flow cell unit of a second embodiment of the present invention;

FIG. 19 is a perspective view showing the internal structure of the flow cell unit of a comparative example;

FIG. 20 is a graph showing the measurement results of the respective orientation ratios of the first and second embodiments and the comparative example; and

FIG. 21 is a perspective view of a modification of the test nozzle used in the flow cell unit of the detecting unit of the embodiment of the present invention.

### DETAILED DESCRIPTION OF THE PREFERRED EMBODIMENTS

The preferred embodiments of the present invention will be described hereinafter with reference to the drawings.

The embodiments of the present invention are described below based on the drawings.

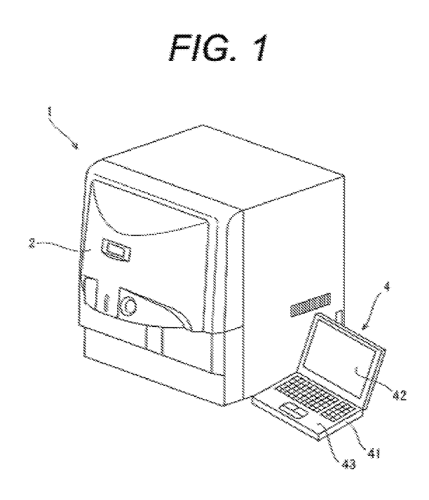

The structure of the cell analyzer 1 of an embodiment of the present invention is described below with reference to FIGS. 1 through 16. In this embodiment, the flow cytometer of the present invention is described by way of example applied to a detecting unit 21 of a measuring device 2 of the cell analyzer 1.

The cell analyzer induces a measurement sample containing cells collected from a patient to flow through the flow cell, and irradiates the measurement sample with laser light as the sample flows through the flow cell. The light (forward scattered light and side fluorescent light) from the measurement sample is detected, and an image is captured of the cell irradiated by the light. Then, a determination is made as to whether there is any abnormality ion the amount of DNA in the cell by analyzing the detected light signals and the captured image. More specifically, the cell analyzer 1 is used to screen for cervical cancer using epithelial cells of the cervix (squamous cells) as the analysis object.

As shown in FIG. 1, the cell analyzer 1 has a measuring device 2 for performing optical measurements of a measurement sample prepared by subjecting a biological sample collected from a subject to cell distribution and staining processes, and a data processing device 4 for analyzing the measurement results obtained by the measuring device 2. The data processing device 4 is configured by, for example, a PC (personal computer), which mainly includes a main body 41, display section 42, and input section 43. An operation program for transmitting operation commands to the measuring device 2, receiving and analyzing measurement results obtained by the measuring device 2, and displaying the processed analysis results and captured images, is installed on the data processing device 4.

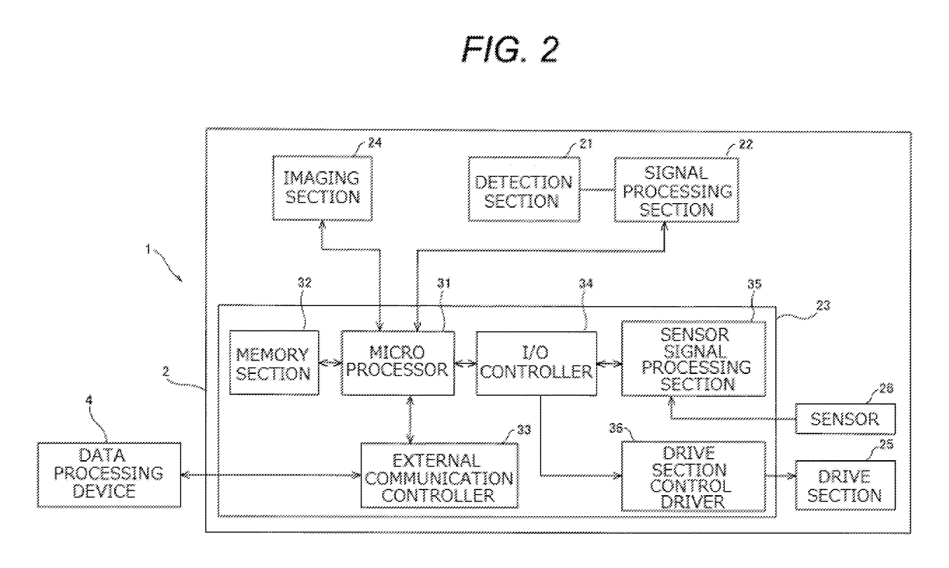

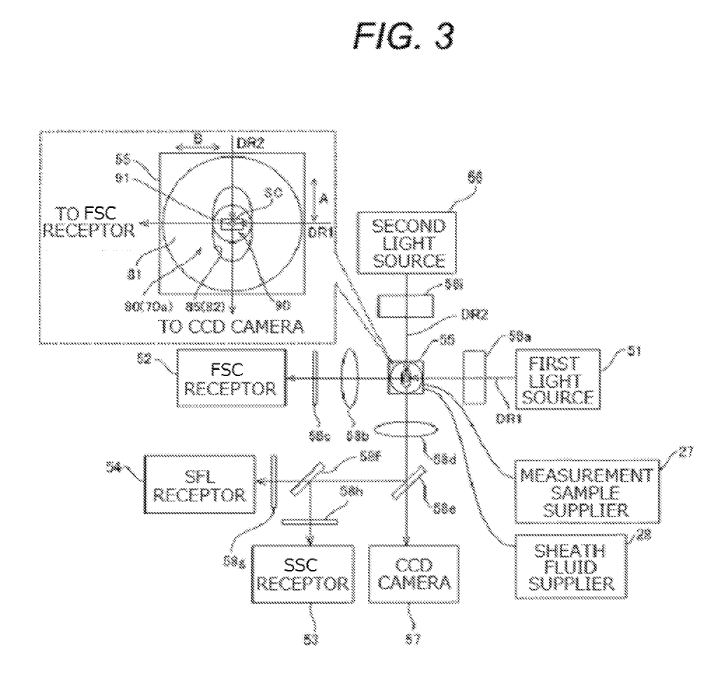

As shown in FIG. 2, the measuring device 2 has a detection section 21, signal processor 22, measurement controller 23, imaging section 24, drive section 25 that includes a motor, actuator and valves, various sensors 26, measurement sample supplier 27 (refer to FIG. 3), and sheath fluid supplier 28 (refer to FIG. 3).

The detection section 21 is configured by a flow cytometer for detecting optical information that reflects the number and size of the measurement object cells (squamous cells of the cervix) and the amount of nuclear DNA from the measurement sample. As shown in FIG. 3, the detection section 21 mainly includes a first light source 51 configured by a semiconductor laser, a forward scattered light receptor 52 configured by a photodiode, a side scattered light receptor 53 and side fluorescent light receptor 54 configured by photomultipliers (photomultiplier tubes), and a flow cell unit 55 with a flow cell 90.

As shown in FIG. 2, the signal processor 22 is configured by various signal processing circuits that perform the necessary signal processing such as amplification, A/D conversion, and filter processing on the output signals from the detection section 21. The measurement controller 23 incorporates a microprocessor 31, memory 32, external communication controller 33, I/O controller 34, sensor signal processor 35, and drive section control driver 36. The memory 32 is configured by a ROM and RAM for storing the control program and data of the detection section 21.

The microprocessor 31 is connected to the data processing device 4 through the external communication controller 33. Hence, the microprocessor 31 is capable of transmitting and receiving various types of data with the data processing device 4. The microprocessor 31 receives signals from the sensors 26 through the sensor signal processor 35 and I/O controller 34. The microprocessor 31 controls the actuation of the drive section 25 through the I/O controller 34 and the drive section control driver 36 based on the signals from the sensors 26. The driver section 26 is capable of supplying measurement sample and sheath fluid from the measurement sample supplier 27 and the sheath fluid supplier 28 to the flow cell unit 55 of the detection section 21.

The imaging section 24 has a second light source 56 configured by a pulse laser, and a CCD camera 57, as shown in FIG. 3. The imaging section 24 is configured to capture an image of the measurement object cells in the measurement sample flowing through the flow cell 90 of the flow cell unit 55.

The measurement sample supplier 27 is configured by a fluid circuit that incorporates an aspirating pipette for aspirating a measurement sample, and a syringe pump for supplying a fixed amount of measurement sample. The sheath fluid supplier 28 is a fluid circuit incorporating a sheath fluid collection chamber connected to a sheath fluid container. The measurement sample supplier 27 and the sheath fluid supplier 28 respectively connected to the flow cell unit 55 of the detection section 21.

The measurement sample is prepared by performing well known processes such as concentrating, diluting, mixing, and staining of a biological sample containing epithelial cells from the uterine cervix of the subject. The staining process is performed using propidium iodide (PI), which is a fluorescent stain containing pigment. Fluorescent light from the nucleus becomes detectable when the nuclei within the cells are selectively stained by PI stain. The prepared measurement sample is accommodated in a test tube, which is place din the cell analyzer 1, the measurement sample is then aspirated by the measurement sample supplier 27 via the aspirating pipette, and thereafter a fixed amount of measurement sample is supplied to the flow cell unit 55 by the syringe pump.

The structures of the detection section 21 and the imaging section 24 are described in detail below.

As shown in FIG. 3, the first light source 51 of the detection section 21 is configured to irradiate laser light on the measurement sample flowing through the flow cell 90 of the flow cell unit 55. The laser light of the first light source 51 is emitted in the DR1 direction, passes through a lens system 58a, and condensed on the measurement sample. The lens system 58a is configured by lens groups including a collimator lens, cylinder lens, condenser lens and the like.

The forward scattered light from the cells in the measurement sample irradiated by laser light passes through the objective lens 58b and filter 58c and is detected by the forward scattered light receiver 52 arranged at the back side in the direction of the optical axis (DR1 direction).

The side scattered light and side fluorescent light from the cells pass through the objective lens 58d arranged at the side (DR2 direction) perpendicular to the optical axis (DR1 direction) to the flow cell 90, and impinges a dichroic mirror 58e. The side fluorescent light and side scattered light reflected by the dichroic mirror 58e impinges a dichroic mirror 58f. The side fluorescent light is transmitted through the dichroic mirror 58f and a filter 58g, and is detected by the side fluorescent light receptor 54. The side scattered light is reflected by the dichroic mirror 58f, passes through a filter 58h, and is detected by the side scattered light receptor 53.

The forward scattered light receptor 52, side scattered light receptor 53, and side fluorescent light receptor 54 convert the received light signals to electrical signals, and respectively output forward scattered light signal (FSC), side scattered light signals (SSC), and side fluorescent light signals (SFL). These output signals are transmitted to the signal processor 22 (refer to FIG. 2) of the measurement device 2. The signal processor 22 of the measurement device 2 acquires FSC data, SSC data, and SFL data by subjecting the output signals to predetermined signal processing. The measurement controller 23 (microprocessor 31) acquires various types of feature parameters, such as forward scattered light intensity, pulse width, side scattered light pulse width, and side fluorescent light intensity, based on the acquired data (FSC, SSC, SFL). The acquired data (FSC data, SSC data, SFL data, and feature parameters) are respectively transmitted by the microprocessor 31 through the external communication controller 33 to the data processing device 4.

The data processing device 4 performs discrimination processing of the particles in the measurement sample based on the various data (FSC data, SSC data, SFL data, and feature parameters) by executing a control program, and determines whether the measurement object cells (epithelial cells) are abnormal, and specifically whether the cells contain an abnormal amount of DNA, then generates frequency distribution data for analyzing the cells and nuclei.

As shown in FIG. 3, the pulse laser light of the second light source 56 of the imaging section 24 is provided to impinge the flow cell 90 from the DR2 direction that is approximately perpendicular to the laser optical axis (DR1 direction) from the first light source 51. The light from the second light source 56 irradiates the measurement sample flowing through the flow cell 90 via the lens system 58i, then is transmitted through the objective lens 58d and dichroic mirror 58e and is imaged on the CCD camera 57 on the inner side in the optical axis direction (DR2 direction).

The image captured by the CCD camera 57 is transmitted by the microprocessor 31 to the data processing device 4 through external communication controller 33. The captured image is associated with the feature parameters determined based on the forward scattered light data (FSC), side scattered light data (SSC) and side fluorescent light data (SFL) of the cells, and stored in a memory device (not shown) built in the data processing device 4.

The structure of the flow cell unit 55 of the detection section 21 is described in detail below.

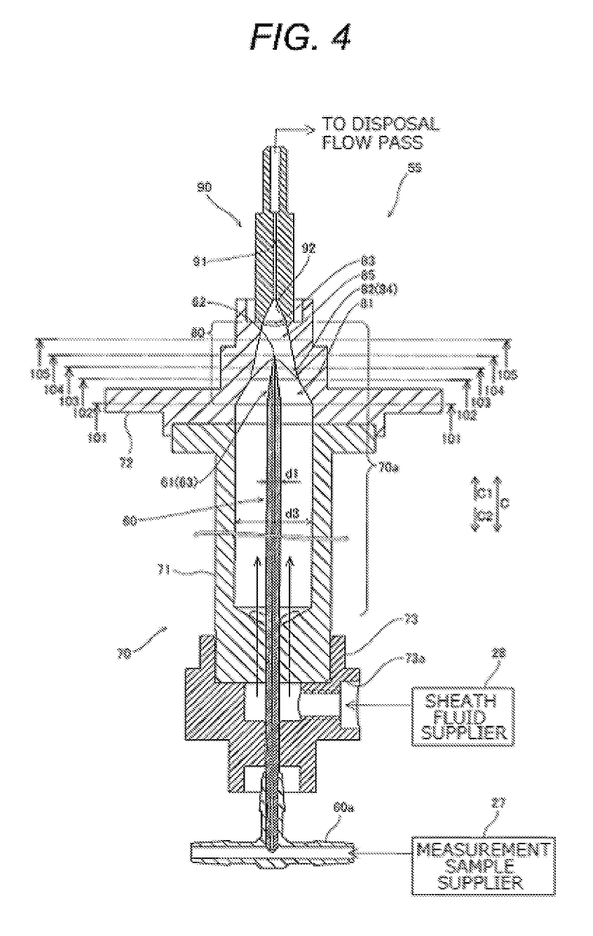

As shown in FIG. 4, the flow cell unit 55 mainly incorporates a sample nozzle 60, sample nozzle receiver 70, first flow pass 91 formed in a flow cell 90.

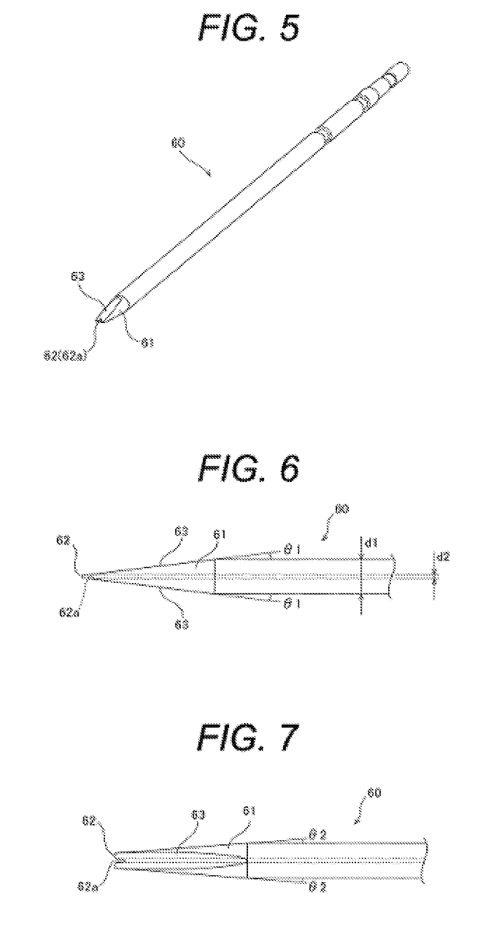

The sample nozzle 60 is a cylindrical tube for supplying a measurement sample containing measurement object squamous cells to the flow cell 90. The sample nozzle 60 is connected to the measurement sample supplier 27 through a connecting member 60a provided at the end on the upstream side(arrow C2 direction). As shown in FIGS. 5 through 7, the outer diameter of the sample nozzle 60 is designated d1, and sample nozzle 60 has a sample flow pass of inner diameter (flow pass diameter) d2. The sample nozzle 60 is configured to discharge the measurement sample from an aperture 62a at the tip 62 on the downstream end formed in a tapered shape.

Two flat surfaces 63 are formed on the exterior surface of the 4 downstream end part 61. The two flat surfaces 63 are formed by cutting part of the cone shaped tip formed on the downstream end 61 in a so-called D-cut double-sided process. The two flat surfaces 63 are formed so as to be mutually opposed with the center axis of the sample nozzle 60 therebetween, and the distances of both are reduced toward the tip. The downstream end 61 has an angle of inclination θ1 (refer to FIG. 6) of the flat surface 63 that is greater than the angle of inclination θ2 (refer to FIG. 7) of the cone-shaped part outside the flat surface 63. Since the thickness in the direction opposite to the two flat surfaces 63 at the tip 62 of the downstream end 61 is less than the internal diameter d2 of the sample nozzle 60, a notch-like concavity is formed in the center part of the tip 62 of the two flat surfaces 63.

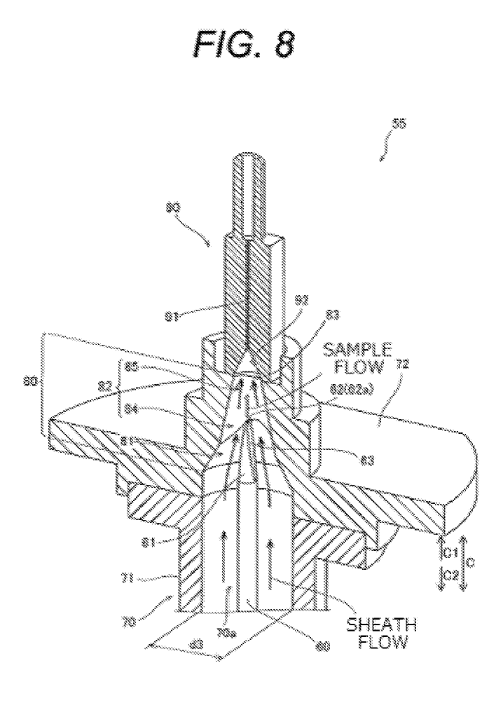

As shown in FIGS. 4 and 8, the sample nozzle receiver 70 incorporates a barrel 71, and an insertion member 72 mounted on the downstream side (C1 direction) of the barrel 71. The barrel 71 and the insertion member 72 are hollow members, and a second flow pass 70a is formed so as to pass through the interior of the barrel 71 and the insertion member 72. An outlet part 83 configured by an aperture is formed at the tip on the downstream side (C1 direction) of the insertion member 72 (second flow pass 70a). The insertion member 72 (second flow pass 70a) is connected to the first flow pass 91 of the flow cell 90 at the outlet part 83.

As shown in FIG. 4, the barrel 71 is a cylindrically shaped member. The flow pass cross section of the second flow pass 70a in the barrel 71 is circular. The internal diameter d3 (flow pass diameter D of the second flow pass 70a) of the barrel 71 is larger than the external diameter d1 of the sample nozzle 60. The barrel 71 accommodates the sample nozzle 60 within the second flow pass 70a. The sample nozzle 60 is inserted and fixed at the upstream end (end in the C2 direction) of the barrel 71. A through hole is formed at the upstream end of the barrel 71 so that the second flow pass 70a is connected to the sheath fluid guide aperture 73a of the connecting member 73. The connecting member 73 is connected to the sheath fluid supplier 28, and configured to be capable of supplying sheath fluid from the sheath fluid supplier 28 to the second flow pass 70a of the barrel 71.

A tapered part 80 that narrows the second flow pass 70a toward the first flow pass 91 (toward the arrow C1 direction) is formed on the guide member 72. The tapered part 80 incorporates an upstream tapered part 81 and downstream tapered part 82, and an output 83 at the downstream end of the second flow pass 70a. Note that the upstream tapered part 81 and the downstream tapered part 82 are respectively examples of the “second tapered part” and “first tapered part” of the present invention.

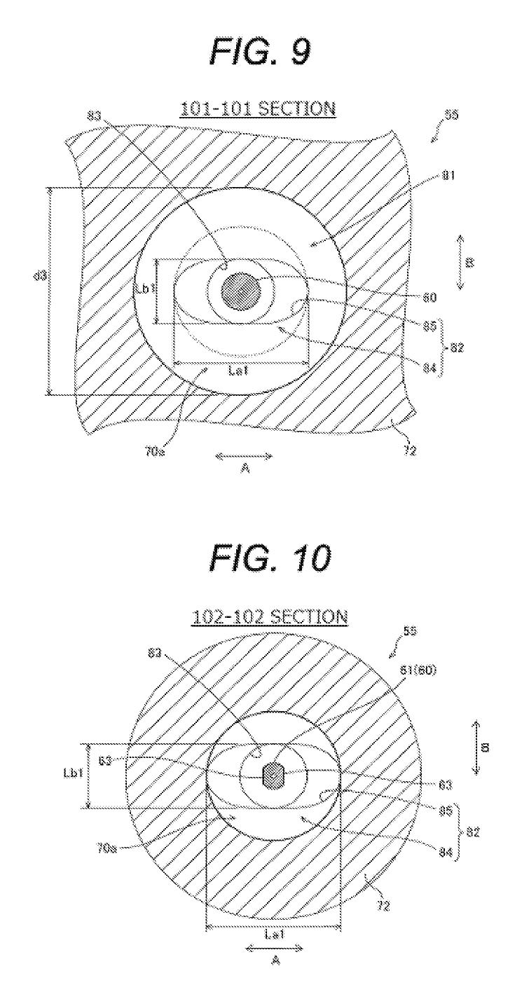

The upstream tapered part 81 is formed so as to connect the downstream tapered part 82 and the second flow pass 70a (the part where the transverse section of the flow pass is circular with flow pass diameter D=d3) of the barrel 71. At the upstream tapered part 81, the second flow pass 70a is conical in shape and is tapered at a fixed angle toward the downstream side (arrow C1 direction). As shown in FIGS. 4 and 9, the transverse section of the second flow pass 70a at the upstream tapered part 81 is circular and similar to the transverse section of the second flow pass 70a at the barrel 71 on the upstream side. At the upstream tapered part 81, the second flow pass 70a maintains a circular transverse section shape, and the flow pass internal diameter D becomes smaller from d3 toward the downstream side (arrow C1 direction).

In the present embodiment, the downstream tapered part 82 is formed so as to be continuous from the mid part of the conical-shaped upstream tapered part 81. The downstream tapered part 82 is configured to have an aspect ratio (aspect radio: A direction dimension/B direction dimension) larger than at the transverse section of the flow pass perpendicular to the flow direction (C direction) of the measurement sample. Specifically, as shown in FIGS. 8 and 9, the downstream tapered part 82 is formed by smoothing connecting the elliptical-shaped flow hole, which has a longitudinal direction (A direction) dimension La1 and a latitudinal direction (B direction) dimension Lb1, to the outlet part 83, which has a circular transverse section of flow pass diameter D=Lb1, so as to constrict the width in the longitudinal direction toward the downstream side.

As shown in FIGS. 4 and 10, the position at which the internal diameter D of the second flow pass 70a is D=La1 becomes the border (the border on the longitudinal direction side) of the upstream tapered part 81 and downstream tapered part 82. Downstream from this position, the aspect ratio is larger than at the transverse section of the second flow pass 70a. As shown in FIG. 8, the borderline of the upstream tapered part 81 and downstream tapered part 82 in the latitudinal direction is curved along the flow direction (C direction) due to the formation of the elliptically-shaped transverse section of the flow hole midway of the conically-shaped upstream tapered part 81.

Therefore, the downstream tapered part 82 has a first part 84 with a transverse section shape that connects a part of the transverse section of the upstream tapered part 81 and a part of the transverse section of the downstream tapered part 82, and has a second part 85 with a transverse section shape consisting of the transverse section of the downstream tapered part 82 at the downstream side of the first part 84. The upstream tapered part 81 and the first part 84 and second part 85 of the downstream tapered part 82 are formed to be smoothly continuous.

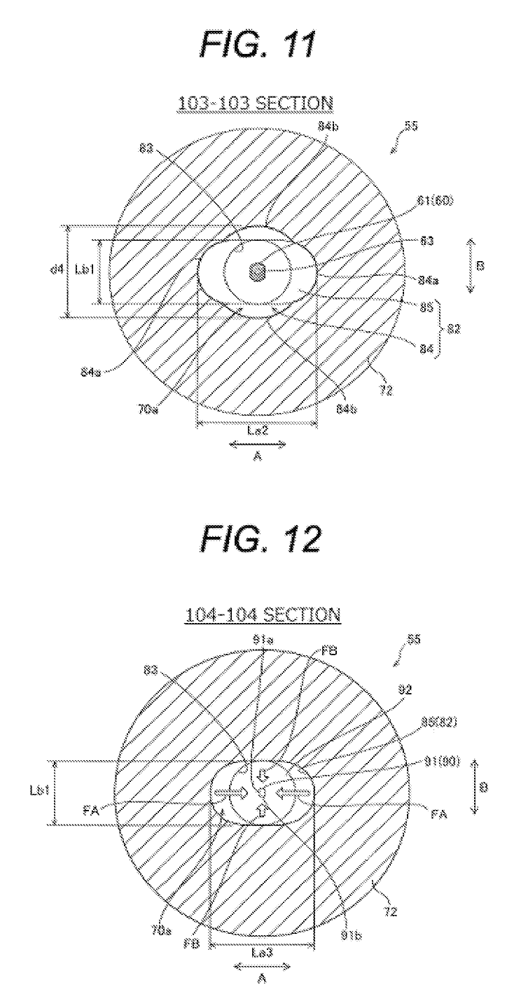

The first part 84 The first part 84 constricts the internal diameter D of the circular transverse section of the upstream tapered part 81, and becomes a region from the position matching the internal diameter D if dimension La1 in the longitudinal direction (A direction) to a position matching the internal diameter D of dimension Lb1 in the latitudinal direction (B direction). As shown in FIGS. 4 and 11, the first part 84 has an elliptical part 84a configuring a part of the transverse section of the downstream tapered part 82 in the bilateral longitudinal direction (A direction), and a circular part 84b configuring a part of the transverse section of the upstream tapered part 81 in the bilateral latitudinal direction (B direction).

As shown in FIG. 11, at the cross section of the mid part 103-103 of the first part 84, the part 84a becomes part of the elliptical (length La2 in the longitudinal direction, length Lb1 in the latitudinal direction) transverse section of the downstream tapered part 82 at bilateral sides in the A direction. The part 84b is configured by a part of the circular (diameter D=d4) transverse section of the upstream tapered part 81 on both sides in the B direction. The aspect ratio of the flow pass cross section of the second flow pass 70a is larger than at Ls2/d4 (La2>d4). The downstream side is the second part 85 from the position at which the diameter D=Lb1 of the circular transverse section part of the upstream tapered part 81.

As shown in FIGS. 4 and 12, the second part 85 is a region from the position configured by the dimension in the latitudinal direction (B direction) at the transverse section of the second flow pass 70a (that is, the position missing from the transverse cross section of the flow pas of part 84b) to the outlet part 83. At the elliptical second part 85, the shape of the transverse section of the second flow pass 70a is constricted in the longitudinal direction (A direction), and the transverse section dimension (Lb1) in the latitudinal direction (B direction) is unchanged. Accordingly, at the second part 85, the aspect ratio increases at the upstream side (arrow C2 direction) end, and the aspect ratio is continuously reduced (aspect ratio approaches ) toward the downstream side (arrow C1 direction).

In the present embodiment, a tip 62 is arranged at the downstream side of the sample nozzle 60 at the second part 85, as shown in FIG. 12. Accordingly, the shape of the transverse section of the second flow pass 70a at the position (position of the 104-104 cross section) of the tip 62 of the sample nozzle 60 at the downstream tapered part 82 is an ellipse symmetrical to the center lines in the longitudinal direction (A direction) and latitudinal direction (B direction). The aspect ratio La3/Lb1 of the transverse section of the second flow pass 70a at the position of the tip 62 of the sample nozzle 60 is configured to be larger than .2. In the present embodiment, the aspect ratio La3/Lb1 of the transverse section of the second flow pass 70a at the position of the 104-104 cross section (the position of the tip 62 of the sample nozzle 60) is approximately 1.6. In the present embodiment, the sample nozzle 60 is arranged with the pair of flat surfaces 63 formed on the downstream end 61 respectively facing parallel to the latitudinal direction (B direction) at the transverse section of the downstream tapered part 82, as shown in FIGS. 10 and 11.

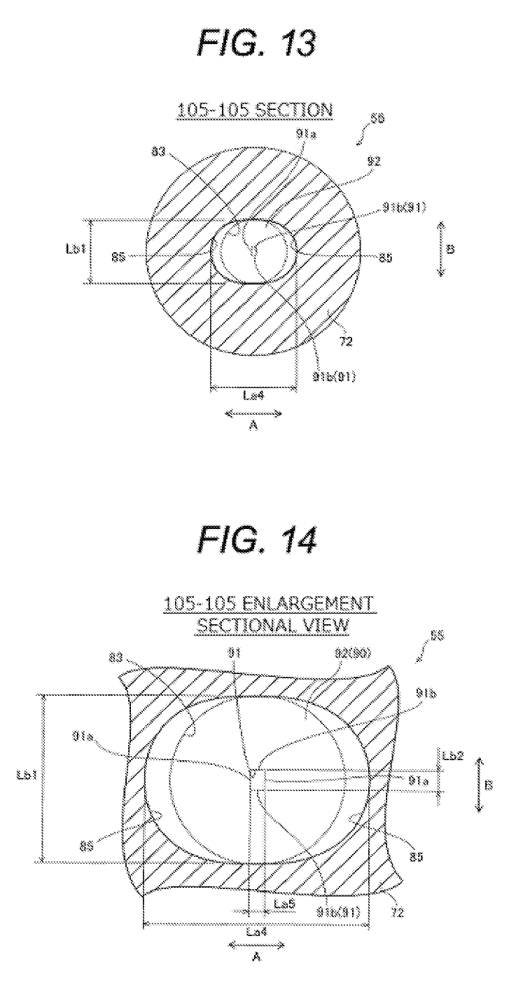

As shown in FIGS. 13 and 14, the aspect ratio La4/Lb1 of the transverse section of the second flow pass 70a at the 105-105 cross section on the downstream side (arrow C1 direction side; refer to FIG. 4) of the second part 85 is smaller than the aspect ratio La3/Lb1 of the transverse section of the second flow pass 70a at the 104-104 cross section. At the outlet part 83, the transverse section is circular in shape and the dimension of the transverse section of the second flow pass 70a in the longitudinal direction (A direction) matches the dimension Lb1 in the latitudinal direction (B direction) (that is, the aspect ratio become ).

As shown in FIGS. 4 and 8, the flow cell 90 incorporates a first flow pass 91, and a connecting floe pass 92 for connecting the first flow pass 91 to the outlet part 83 of the second flow pass 70a.

The connecting flow pass 92 is a conically shaped flow pass that connects with the outlet part 83 that has a circular transverse section. The connecting flow pass 92 is configured to narrow the flow pass of diameter Lb1 at a fixed angle toward the downstream side (arrow C1 direction) so as to connect to the first flow pass 91.

The first flow pass 91 has a rectangular shaped transverse section surface, and the aspect ratio of the transverse section is larger than 1. Specifically, the transverse section of the first flow pass has dimension Lb2 on the long edge (longitudinal direction) 91a and a dimension La5 in the short edge (latitudinal direction) 91b, as shown in FIG. 14. In the present embodiment, the longitudinal direction (long edge 91a) of the transverse section of the first flow pass 91 and the latitudinal direction (B direction) of the transverse section of the downstream tapered part 82 of the second flow pass 70a are approximately parallel.

When the sample flow containing the measurement object cells is passing through the first flow pass 91 of the flow cell 90 during the measurements, light emitted from the first light source 51 and second light source 56 irradiates flow from the sides of the flow cell 90 (first flow pass 91). In the present embodiment, the optical axis direction DR1 of the laser light from the first light source 51 is parallel to the longitudinal direction of the first flow pass 91 (B direction; latitudinal direction of the downstream tapered part 82), as shown in FIG. 3. The optical axis direction DR2 of the light from the second light source 56 is parallel to the latitudinal direction (A direction) of the first flow pass 91. That is, the imaging section 24 is configured to capture images from a direction that is parallel to the longitudinal direction (A direction; latitudinal direction of the first flow pass 91) at the transverse section of the downstream tapered part 82.

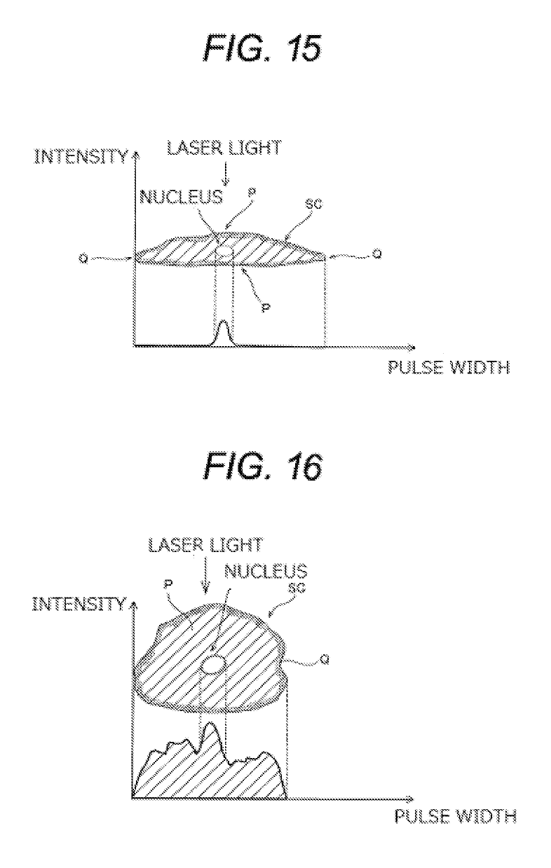

Referring now to FIGS. 2 through 4 and FIGS. 8 through 16, the orientation of the measurement object cells contained in the sample flow that flows through the flow cell unit 55 is described below during measurements performed by the detection section 21 (flow cytometer) of the measuring device 2 of the present invention. As shown in FIGS. 15 and 16, the squamous cells SC have a flat shape configured by a flat surface P, and a peripheral side surface Q. In the following description, the longitudinal direction (direction parallel to the flat surface P) when viewing from the side surface Q is designated the longitudinal direction of the measurement object cells, and the latitudinal direction (thickness direction of the cells) when viewed from the side surface Q is designated the latitudinal direction of the measurement object cells. The orientation refers to the flat surface P of the squamous cells flowing through the flow cell unit 55 toward a fixed direction, and the orientation ratio refers to the percentage of the number of epithelial cells which have the flat surface P facing the fixed direction relative to the total number squamous cells of the measurement object.

As shown in FIG. 4, the orientation of the measurement object cells SC is accomplished by discharging the measurement sample containing the measurement object cells in a sheath flow formed by supplying a sheath fluid to the flow cell unit 55, and using the force of the sheath flow of a predetermined direction to act on the measurement object cells SC.

As shown in FIGS. 2 through 4, the sheath fluid is supplied from the sheath fluid supplier 28 into the interior (second flow pass 70a) of the sample nozzle receiver 70 (barrel 71) through the connecting member 73 by the microprocessor 31 controlling the actuation of the drive section 25. The sheath fluid flows into the second flow pass 70a at a predetermined volumetric flow rate to fill the flow pass, and forms a sheath flow in the arrow C1 direction from the back end (upstream end) of the barrel 71 toward the downstream side (guide member 72 side).

When the sheath flow flows into the guide member 72, the second flow pass 70a is constricted by the tapered part 80. When the sheath flow arrives at the conical upstream tapered part 81 as shown in FIG. 9, an inward force toward the center is generated at the transverse section of the flow pass by the reduced inner diameter D of the second flow pass 70a and the compression of the sheath flow. In this case, since the inner diameter D of the flow pass is uniformly reduced, the direction of the inward force is approximately constant.

As shown in FIG. 11, when the sheath flow arrives at the first part 84 of the downstream tapered part 82, the aspect ratio of the second flow pass 70a is larger than . Since the flow pass dimension in the latitudinal direction (B direction) is greatly reduced (aspect ratio is increased) compared to the reduced flow pass dimension in the longitudinal direction (A direction) at the first part 84, the sheath flow is greatly compressed in the latitudinal direction (B direction).

As shown in FIG. 12, when the sheath flow arrives at the second part 85 of the downstream tapered part 82, the transverse section of the second flow pass 70a becomes elliptical. At the second part 85, the flow pass dimension in the latitudinal direction (B direction) becomes a constant Lb1, and the flow pass dimension in the longitudinal direction (A direction) decreases toward the downstream side. Therefore, the sheath flow is compressed in the longitudinal direction (A direction, and the a pressure distribution is generated whereby the pressure on bilateral side of the longitudinal direction at the transverse section of the second flow pass 70a becomes greater than the pressure on bilateral sides of the latitudinal direction.

The sample containing the measurement object cells SC is discharged from the tip 62 of the sample nozzle 60 at the position of the 104-104 cross section (second part 85; refer to FIG. 12) when the above described sheath flow pressure distribution has formed. The measurement sample flows from the measurement sample supplier 27 into the back end (upstream end) of the sample nozzle 60 through the connecting member 60a, and a predetermined volumetric flow is discharged from the tip 62 into the center of the sheath flow. The measurement sample discharged from the tip 62 of the sample nozzle 60 becomes a flat sample flow along the B direction because the measurement sample is constrained from bilateral sides in the A direction by the sheath flow that flows around the sample nozzle 60 and along the flat surface 63 that is inclined to the inner side at the downstream end.

Then, among the forces acting on the measurement object cells SC by the sheath flow with the above pressure distribution, the force FA from bilateral sides in the longitudinal direction (A direction) toward the inside becomes greatest, and the force FB from the bilateral sides in the latitudinal direction (B direction) toward the inside becomes relatively smaller. Therefore, the measurement object cells SC in the sample flow are oriented so that the flat surface P (refer to FIG. 15) of the measurement object cells SC receive the force FA in the longitudinal direction toward the inner side. That is, the measurement object cells are oriented so that the flat surface P is along the latitudinal direction (B direction). Hence, the measurement object cells SC are oriented while passing through the second part 85 of the downstream tapered part 82, and enter the connecting flow pass 92 of the flow cell 90 from the outlet part 83 of the second flow pass 70a to arrive at the first flow pass 91.

As shown in FIGS. 8 and 14, since the long edge 91a is parallel to the B direction and the short edge 91b is parallel to the A direction at the first flow pass 91, the orientation ( ) of the oriented measurement object cells SC (longitudinal side in B direction, latitudinal side in A direction) matches the longitudinal direction and latitudinal direction of the first flow pass 91. Therefore, the measurement object cells SC that are oriented at the downstream tapered part 82 advance through the first flow pass 91 with their orientation unchanging.

As shown in FIG. 3, when the flow containing the measurement object cells SC arrives at the detection position, laser light emitted from the first light source 51 irradiates the flow from the B direction and optical measurements are performed. The imaging section 24 captures images from the A direction. Hence, it is possible to capture images of the measurement object cells SC from the front side (A direction) while the cells have the flat surface P oriented in the latitudinal direction (B direction). The cell aggregation and state of the nucleus can be accurately observed by capturing images of the measurement object cells SC from the front side.

During optical measurement using the laser light of the first light source 51, the waveforms of the signals detecting the direction of the measurement object cells SC (forward scattered light signal (FSC), side scattered light signal (SSC), and side fluorescent light signal (SFL)) are different.

FIG. 16 is an illustration of the irradiation by laser light from the side surface of the Q side of the measurement object cells SC (irradiation from the B direction approximately parallel to the flat surface P) and imaging of the measurement object cells SC from the front side in the present embodiment. FIG. 16 shows a captured cell image. As shown in FIG. 16, using the forward scattered light signal (SFC) as an example, a signal waveform of increasing strength along the entire width of the pulse width is detected with the exterior shape of the cell reflected in the steep rise and fall of the signal.

FIG. 15 shows an illustration of laser light irradiation of the cell SC from the front and image capture of the measurement object cell SC from the side surface on the Q side. FIG. 15 shows a captured cell image. As shown in FIG. 15, only the part of the nucleus of the cell forms the signal peak, and the part outside the nucleus has decreasing signal strength.

Hence, the detected signal waveforms differ depending on the cell direction, even for the same cell. The accuracy of cell analysis can thus be improved by irradiating laser light on the cells having uniform orientation and detecting the signal waveforms without variation.

In the present embodiment described above, the sample nozzle receiver 70 is provided with a tapered part 80 in which the second flow pass 70a becomes narrower toward the first flow pass 91, and the downstream tapered part 82 of the tapered part 80 is formed so that the aspect ratio is larger than at the transverse section of the flow pass intersecting the flow direction of the measurement sample, and the tip 62 on the downstream side of the sample nozzle 60 is arranged at the downstream tapered part 82. Hence, the inclination of the constriction of the second flow pass 70a at the downstream tapered part 82 is greater on the side in the longitudinal direction (A direction) than on the side in the latitudinal direction (B direction) of the transverse section of the flow pass. A relatively high pressure is therefore produced in the sheath flow at the downstream tapered part 82 at the bilateral sides in the longitudinal direction (A direction) of the flow pass cross section compared to the bilateral sides in the latitudinal direction (B direction). Since the tip 62 of the sample nozzle 60 is arranged at the downstream tapered part 82, when a measurement sample containing the measurement object cells is supplied into the sheath flow, a force FA acts from the longitudinal direction of the bilateral sides toward the interior of the flow pass cross section of the downstream tapered part 82 to constrict the measurement object cells and orient the measurement object cells in the B direction. Hence, the orientation ratio of the measurement object cells is greatly improved.

Since the cell orientation is varied when the orientation ratio of the measurement object cells is low, when the measurement results (captured images and signals) are acquired for a large number of measurement object cells in a measurement sample, the measurement results will include a mix of images captured from the front surface P and image captured from the side surface Q, and a mix of signal waveforms as shown in FIGS. 15 and 16. Therefore, the aggregation of cells and the condition of the nuclei cannot be accurately observed from these images, and the accuracy of analysis based on optical measurement is also reduced due to the variability of the waveforms of the various signals (FSC, SSC, SFL). Conversely, variability of the measurement results is suppressed in the present embodiment due to the improved orientation ratio of the measurement object cells and, as a result, analysis accuracy of epithelial cells of the cervix (squamous cells) is improved.

In the present embodiment described above, two flat surfaces 63 that reduce the distance of both toward the tip 62 are formed so as to be mutually opposed at the outside of the downstream end 61 (tip 62) of the sample nozzle 60, and so that the two flat surfaces 63 are parallel to the latitudinal direction (B direction) at the transverse section of the downstream tapered part 82 of the tapered part 80. The sample flow of the measurement sample supplied from the sample nozzle 60 thus forms a flat flow along the latitudinal direction (B direction) a the transverse section of the downstream tapered part 82 by having the sheath flow surrounding the sample nozzle 60 flow along the two flat surfaces 63. Since both sides of the flat sample flow can be constricted by the sheath flow on bilateral sides in the longitudinal direction (A direction), the force FA, which is exerted from the longitudinal direction (A direction) of the bilateral sides toward the interior at the downstream tapered part 82, effectively acts on the measurement object cells in the sample flow, and the orientation ratio of the measurement object cells is markedly improved.

In the present embodiment described above, the transverse section of the second flow pass 70a is circular at the outlet part 83 of the tapered part 80. Thus, disruption of the direction of the measurement object cells which have been oriented in a fixed direction is inhibited due to the suppression of turbulence generation when the sheath flow and sample flow containing the measurement object cells flow out of the tapered part 80.

In the present embodiment described above, the first flow pass 91 is formed in a rectangular shape with a transverse section aspect ratio larger than, and the latitudinal direction (B direction) of the transverse section of the downstream tapered part 82 of the second flow pass 70a is parallel to the longitudinal direction of the transverse section of the first flow pass 91. Since, at the downstream tapered part 82, the long side of the flat measurement object cell is oriented along the latitudinal direction (B direction) of the downstream tapered part 82, the longitudinal direction of the transverse section of the first flow pass 91 of the flow cell 90 matches the longitudinal direction of the oriented measurement object cells. Therefore, any change in the orientation of the oriented measurement object cells in the downstream tapered part 82 is effectively suppressed since the longitudinal and latitudinal directions of the first flow pass 91 respectively match the longitudinal and latitudinal directions of the oriented measurement object cells.

The two flat surfaces 63 are formed at the downstream end 61 of the sample nozzle 60 in the embodiment described above. Therefore, the two inclined surfaces (flat surfaces 63) are easily formed to reduce the distance of both toward the tip, and to be mutually opposed.

In the above described embodiment, the transverse section has an aspect ratio larger than 1.2 at the position of the tip 62 of the sample nozzle 60 at the downstream tapered part 82. The orientation ratio of the measurement object cells is therefore greatly improved due to the markedly greater pressure differential (difference in the magnitude of the force toward the interior) of bilateral sides of the flow pass transverse section in the longitudinal direction (A direction) and bilateral sides in the latitudinal direction (B direction.

In the above described embodiment, the shape of the transverse section in the downstream tapered part 82 at the position (refer to the 104-104 cross section in FIG. 12) of the tip 62 of the sample nozzle 60 is symmetrical to the center lines in the longitudinal direction and latitudinal direction. The bilateral forces in the longitudinal direction (A direction) of the flow pass transverse section are therefore approximately equal and the bilateral forces in the latitudinal direction (B direction) of the flow pass transverse section are therefore approximately equal at the downstream tapered part 82. Hence, the force toward the interior acting on the measurement object cells is approximately equal on the bilateral sides in the longitudinal direction and bilateral sides in the latitudinal direction.

In the embodiment described above, a flow pass transverse section shape that is respectively symmetrical to the center lines in the longitudinal direction (A direction) and latitudinal direction (B direction) is readily obtained by forming the transverse section of the flow pass so as to have an elliptical shape at the position of the tip 62 of the sample nozzle 60 at the downstream tapered part 82.

In the present embodiment described above, the downstream tapered part 82 is formed so as to be continuous from the mid part of the conical-shaped upstream tapered part 81. The second flow pass 70a is therefore smoothly constricted by connecting to the downstream tapered part 82 that has an aspect ratio larger than 1 through the conical upstream tapered part 81. Hence, the creation of turbulence is suppressed when the sheath flow enters the tapered part 80.

In the embodiment described above, the downstream tapered part 82 is provided a the first part 84 has a transverse section shape that connects part of the transverse section of the upstream tapered part 81 and part of the downstream tapered part 82, and a second part 85 that has a transverse section shape that only configures the downstream tapered part 82 at the downstream side of the first part 84, and the upstream tapered part 81 of the tapered part 80, and the first part 84 and second part 85 of the downstream tapered part 82 are formed so as to be smoothly continuous. Hence, the second flow pass 70a, which extends from the conical upstream tapered part 81 to the downstream tapered part 82 (second part 85) with an aspect ratio larger than 1, can be smoothly and continuously connected through the first part 84 by forming the first part 84 with a transverse section shape that connects a part of the transverse section (circular shape) of the upstream tapered part 81 and a part of the transverse section (elliptical shape) of the downstream tapered part 82, and connecting to the second part 85 with a transverse section shape configuring only the transverse section (elliptical shape) of the downstream tapered part 82.

In the embodiment described above, the creation of turbulence when the sample flow enters the first flow pass 91 from the second flow pass 70a can be suppressed because the shape of the transverse section of the flow pass changes smoothly from the outlet part 83 of the tapered part 80 to the first flow pass 91 of the flow cell 90 by connecting the first flow pass 91 to the outlet part 83 of the tapered part 80 of the second flow pass 70a, and providing an approximately conically shaped connecting flow pass 92 to constrict the flow pass toward the first flow pass 91.

In the above described embodiment, the imaging section 24 is provided to capture images of the measurement object cells flowing through the first flow pass 91 of the flow cell 90 from a direction parallel to the longitudinal direction (A direction) at the transverse section of the downstream tapered part 82 of the tapered part 80. Imaging is therefore performed from the front side of the flat measurement object cells because the longitudinal side of the flat measurement object cell is oriented along the latitudinal direction (B direction) of the flow pass by the inward force FA in the latitudinal direction (A direction) of the transverse section of the flow pass at the downstream tapered part 82.

In the embodiment described above, squamous cells can be oriented in a fixed direction with high probability (increased orientation ratio) when squamous cells are the measurement object. As a result, the configuration is particularly effective when squamous cells are the measurement object since variation of measurement data caused by the orientation of the squamous cells is reduced.

### EXAMPLES

Comparative experiments verifying the effectiveness of the present invention are described below with reference to FIG. 7, FIGS. 9 through 12, and FIGS. 14 through 20.

In these comparative experiments, three flow cell units, including examples 1 and 2 and a reference example, were used and the measurement object cells SC flowing through the cell were imaged by the imaging section 24, then the orientation ratio of the measurement object cells SC was calculated from captured images, and the results compared.

The structures of flow cells used in examples 1 and 2 and the reference example are discussed below.

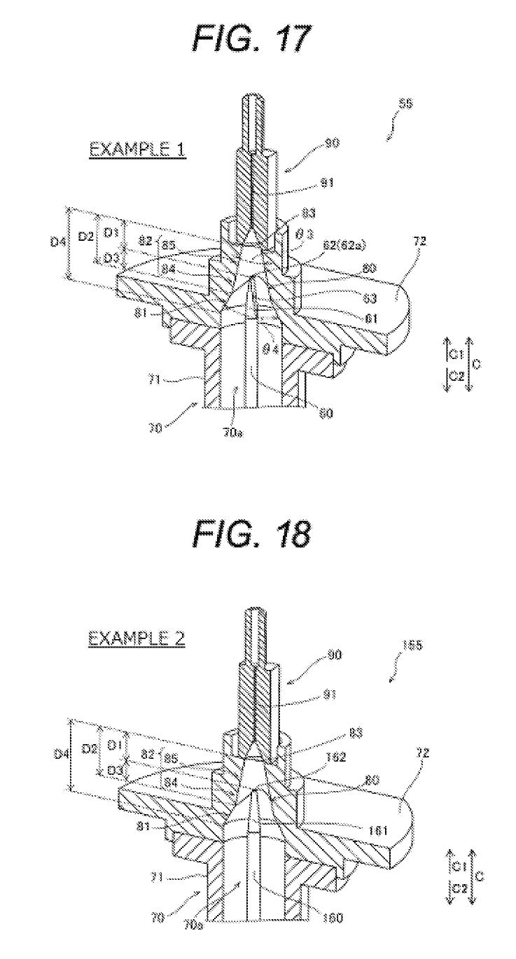

In example 1, the flow cell 55 of the above embodiment was used. In example as shown in FIG. 17, the downstream tapered part 82 was formed by smoothly connecting an elliptically shaped through hole (refer to FIG. 9), provided with a dimension La1 in the longitudinal direction (A direction) of 5.0 mm and a dimension Lb1 in the latitudinal direction (B direction) of 2.5 mm, to a circular shaped outlet part 83 provided with a flow pass diameter D of 2.5 mm (Lb1). The angle of inclination θ3 was 50° in the longitudinal direction of the second part 85, and the angle of inclination θ4 was 60° at the upstream tapered part 81.

In example 1, the back end of the second flow pass 70a was designated the standard position, and the tip 62 of the sample nozzle 60 was arranged at a position a distance D1 of 3.55 mm (second part 85) in the arrow C2 direction from the standard position. The dimension La3 (refer to FIG. 12) in the longitudinal direction of the transverse section of the second flow pass 70a was approximately 5.5 mm at the position of the tip 62, and the aspect ratio La3/Lb1 of the transverse section of the second flow pass 70a was approximately 2.2. Note that the distance D2 from the standard position to the upstream end (arrow C2 direction) of the first part 84 was 6.55 mm, and the distance D3 between the upstream end of the first part 84 and the tip 62 of the sample nozzle 60 was 3.0 mm. The distance D4 was 8.7 mm from the standard position to the upstream end of the tapered part 80.

The first flow pass 91 of the flow cell 90 of example has a long edge 91a with a dimension Lb1 of 300 μm in the transverse section (refer to FIG. 14), and a short edge 91b with a dimension La5 of 250 μm. The transverse section of the first flow pass 91 has an aspect ratio Lb2/La5 of 1.2.

The flow cell 55 of example 2 differed from example 1 (flow cell unit 55) only in the sample nozzle, as shown in FIG. 18. Specifically, the sample nozzle 60 of example (flow cell unit 55) with a flat part 63 was different inasmuch as a sample nozzle 160 with a conical shaped downstream end 161 without a flat part was used. The angle of inclination of the downstream end 161 was equal to the angle of inclination θ2 of the conically shaped part outside the flat part 63 of the sample nozzle 60 (refer to FIG. 7) of the example 1 (flow cell unit 55). The tip 162 of the sample nozzle 160 was arranged at a position a distance D of 4.55 mm from the standard position similar to example 1. Accordingly, the transverse section of the second flow pass 70a at the position of the tip 162 had an aspect ratio of approximately 2.2 (identical to example 1). In other respects the structure of example 2 was identical to the structure of the flow cell unit 55 of the above embodiment (example 1).

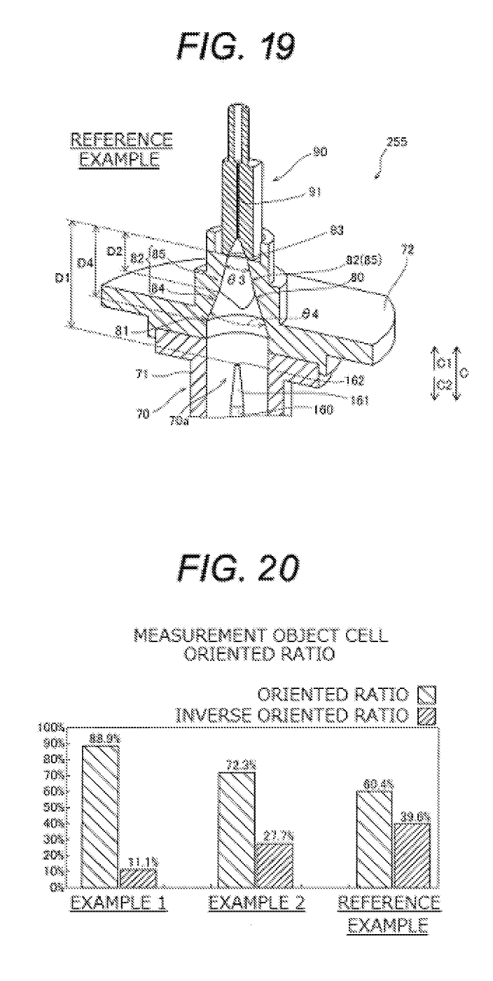

The flow cell unit 255 of the reference example has moved the position of the tip 162 of the sample nozzle 160 to the upstream side (arrow C2 direction) from the tapered part 80 in the structure of example 2, as shown in FIG. 19. Specifically, in the flow cell unit 255 of the reference example, the position of the tip 162 in example 2 (distance D1=3.55 mm) was moved upstream approximately 15 mm to have the tip 162 of the sample nozzle 160 arranged at a position a distance D1 of 18.7 mm from the standard position. In other respects the structure of the flow cell 255 of the reference example is identical to the flow cell unit 55 of example 2. Note that the distance D4 from the standard position to the upstream end of the tapered part 80 is accordingly 8.7 mm. Therefore, in the reference example, the tip 162 of the sample nozzle 160 is upstream from the tapered part 80, and arranged within the barrel 71. The transverse section of the second flow pass 70a has an aspect ratio of 1 at the position of the tip 162.

Using the flow cell units of examples 1 and 2 and the reference example, images of the measurement object cells SC were captured and the orientation ratios (and inverse orientation ratios) were calculated. Specifically, the image from the side surface Q side of the measurement object cell SC shown in FIG. 16 was defined as “oriented,” the image from the front surface P side of the measurement object cell SC shown in FIG. 15 was defined as “inverse oriented,” and the calculated percentage of the number of “oriented” images among all images was designated the “orientation ratio” (and the percentage of the number of “inverse oriented” images was designated the “inverse orientation ratio”). Note that images that were not classified as either “oriented” or “inverse oriented” (not discriminatable) were excluded. The obtained experimental results are shown in FIG. 20. In the reference example, approximately 220 images of the measurement object cells SC were captured, and the orientation ratio was calculated from the obtained images. The flow cell units (55, 155, and 255) were each produced more than six times, and the average value of the calculated orientation ratios are shown in FIG. 20.

When comparing the experimental results, example 2 (orientation ratio 72.3%) exhibited an 11.9% improvement in orientation ratio over that of the reference example (orientation ratio 60.4%). When comparing the reference example (refer to FIG. 19) and example 2 (refer to FIG. 18), the only aspect of difference was the position of the tip 162 of the sample nozzle 160 on the upstream side from the tapered part 80 (the position within the barrel 71; aspect ratio=1 at the second flow pass 70a) in the flow cell unit 255 of the reference example, and the position of the tip 162 of the sample nozzle 160 at the second part 85 of the downstream tapered part 82 (second flow pass 70a aspect ratio approximately 2.2) in the flow cell unit 155 of example 2. Therefore, the orientation ratio was improved in example 2 by adjusting the position of the tip 162 of the sample nozzle 160 to arranged the tip 162 of the sample nozzle 160 at the second part 85 (second flow pass 70a aspect ratio approximately 2.2) of the downstream tapered part 82.

This result confirms the orientation ratio was greatly improved by arranging the tip 162 of the sample nozzle 160 at the downstream tapered part 82 (second part 85) which has a flow pass transverse section aspect ratio larger than 1.

In example 1 (orientation ratio 88.9%), the orientation ratio was 16.6% larger than that of example 2 (orientation ratio 72.3%). In comparison with the flow cell unit 155 of example 2, it can be understood that the flow cell unit 55 of example 1 improved the orientation ratio by forming the flat surfaces 63 on the sample nozzle 60 since the only aspect of difference was the flat surfaces 63 formed on the downstream end 61 of the sample nozzle 60 in example 1. This result further confirms an improved orientation ratio was obtained by forming two flat surfaces 63 mutually opposed so as to shorten the distance of both toward the tip 62, and arranging these two flat surfaces 63 parallel to the transverse section in the latitudinal direction (B direction) of the downstream tapered part 82 of the tapered part 80.

Note that the embodiment and each example of the present disclosure are examples in all aspects and not to be considered limiting in any way. The scope of the present invention is expressed by the scope of the claims and not by the description of the embodiment or various examples, and includes all meanings and equivalences and modifications pertaining thereunto.

For example, although the present invention is described by way of example applied to the detection section 21 of the measuring device 2 in a cell analyzer 1 for analyzing epithelial cell of the cervix, the present invention is not limited to this application. The present invention is also applicable to the detection section (flow cytometer) of cell analyzers for analyzing cells other than epithelial cells of the cervix, such as cell in urine sample or blood sample. Although the above embodiment is described by way of example of a cell analyzer 1 provided with a measuring device 2 having a built in data processing device 4 and detecting section 21, the present invention is not limited to this example inasmuch as a separate measuring device or separate detecting section also may be used.

The embodiment has been described by way of example of providing two flat surfaces 63, which are inclined to reduce the distance of both toward the tip 62, on the downstream end 61 of the sample nozzle 60 as an example of the inclined surface of the present invention; however, the present invention is not limited to this example. In the present invention, the inclined surface (flat surface 63) need not be provided. That is, the inclined surface need not be flat inasmuch as the surface may be curved.

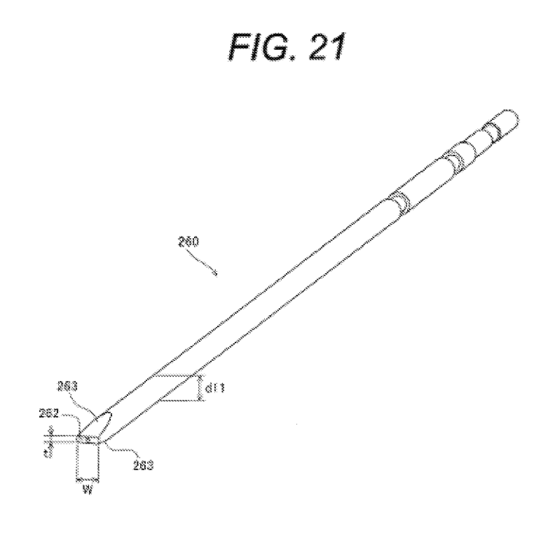

Although the embodiment above has been described by way of example of providing two flat surfaces 63 (inclined surfaces) on the downstream end 61 of the sample nozzle 60, the present invention is not limited to this example. In the present invention, the downstream end also need not be formed in a conical shape, as shown in the modification in FIG. 21. In this modification, the two flat surfaces 263, which are inclined to shorten the distance of both toward the end 262, are formed on the sample nozzle 260. In the sample nozzle 260, the flat surfaces 263 are formed by constricting the downstream end of the cylindrical sample nozzle 260 in a conical shape, or diagonally cutting the outer circumferential surface. Thus, unlike the above embodiment, the thickness t in the direction of the two facing flat surfaces 263 becomes less than the external diameter d11 of the sample nozzle 260 at the tip 262, whereas the width W does not decrease so that so as to be equal to the external diameter d11. The sample nozzle 260 of this modification does not require the downstream end 61 to be conical in shape, hence, a sample nozzle with two inclined surfaces can be easily obtained.

Although the transverse section of the second flow pass 70a is elliptical in shape at the downstream tapered part 82 (second part 85) in the above embodiment, the present invention is not limited to this example. In the present invention, the transverse section at the downstream tapered part (second part) also may be ovoid and rectangular. Further, the transverse section at the downstream tapered part (second part) also may be polygonal such as hexagonal and octagonal, polygonal, or rounded rectangle shape with R corners.

In the above embodiment the transverse section of the second flow pass 70a is described to have an aspect ratio larger than 1.2 at the position of the tip 62 of the sample nozzle 60 (refer to FIG. 12), the present invention is not limited to this example. In the present invention, the transverse section of the second flow pass 70a also may have an aspect ratio larger than 1 but 1.2 or less at the position of the tip 62 of the sample nozzle 60.

Although the above embodiment is described by way of example in which the tip 62 of the sample nozzle 60 is arranged at the second part 85 of the downstream tapered part 82, the present invention is not limited to this example. In the present invention, the tip 62 of the sample nozzle 60 also may be arranged at the first part 84 of the downstream tapered part 82. The tip 62 of the sample nozzle 60 also may be arranged at a position at which the transverse section of the second flow pass 70a has an aspect ratio larger than 1.

Although the transverse section of the second flow pass 70a is circular in shape at the outlet part 83 in the above embodiment, the present invention is not limited to this example. In the present invention, the transverse section at the outlet part 83 also may have an elliptical in shape similar to the shape of the transverse section at the downstream tapered part 82 (second part 85). Further, the transverse section of the second flow pass 70a may have a transverse section shape other than circular or elliptical at the outlet part.

Although the above embodiment is described by way of example of the second flow pass 70a having an internal diameter designated Lb1 at the circular outlet part 83 to match the elliptical shape in latitudinal direction (B direction) of the downstream tapered part 82, the present invention is not limited to this example. In the present invention, the internal diameter of the outlet part 83 also may be smaller than Lb1. In this case, in the second part 85, not only the dimension in the longitudinal direction (A direction), but also the dimension in the latitudinal direction (B direction) may decrease toward the downstream side.

The above embodiment is described by way of example in which the aspect ratio of the second flow pass 70a becomes 1 at the outlet part 83, and the aspect ratio decreases toward the downstream side at the elliptical downstream tapered part 82 (second part 85) (that is, the aspect ratio approaches 1); however, the present invention is not limited to this example. In the present invention, the aspect ratio of the second flow pass 70a at the outlet part 83 also may match the aspect ratio of the elliptical shape of the downstream tapered part 82 (second part 85). That is, the aspect ratio of the transverse section of the second flow pass 70a need not change, and the shape of the transverse section may maintain a similar shape or only the surface area of the transverse section decreases.

The above embodiment is described by way of example of providing an upstream tapered part 81 having a conical shape so as to connect the second flow pass 70a on the barrel 71 side (the part with a transverse section having a circular shape with a flow pass diameter D=d3) and the downstream tapered part 82; however, the present invention is not limited to this example. In the present invention, the upstream tapered part also may have a shape other than conical. The dimension in the longitudinal direction of the elliptical shape of the downstream tapered part 82 may match the flow pass diameter of the second flow pass 70a on the barrel 71 side (that is, the dimension La1 in the A direction may match d3; refer to FIG. 9). In this case, the tapered part 80 and the second flow pass 70a are connected on the barrel 71 side by the first part 84 that connects the conical shape part and the elliptical shape part.

Although the above embodiment is described by way of example providing a connecting flow pass 92 to connect the first flow pass 91 and the outlet part 83 of the second flow pass 70a in the flow cell 90, the present invention is not limited to this example. In the present invention, the connecting flow pass 92 also may be formed on the sample nozzle receiver 70 side (guide member 72).

What is claimed is:

1. a flow cytometer, comprising:
a sample nozzle for passing a measurement sample containing a measurement object;
a flow cell with an interior first flow pass, the flow cell being arranged downstream from the sample nozzle;
a sample nozzle receiving section with an interior second flow pass that communicates with the first flow pass and has a larger internal diameter than the exterior diameter of the sample nozzle, configured to hold the sample nozzle within the second flow pass;
a measurement sample supplying section for supplying a measurement sample to the sample nozzle; and
a sheath fluid supplying section for supplying sheath fluid to the second flow pass of the sample nozzle receiving section; wherein
the sample nozzle receiving section comprises at least in part a tapered part for narrowing the second flow pass toward the first flow pass;
the tapered part has a first tapered part with an aspect ratio larger than 1 of the transverse section of the flow pass intersecting the flow direction of the measurement sample; and
the end on the downstream side of the sample nozzle is arranged at the first tapered part of the tapered part.

2. The flow cytometer of claim 1, wherein
two inclined surface parts are formed at the outer side of the downstream end of the sample nozzle, the inclined surface parts both having a shorter distance toward the end; and
the two inclined surface parts are approximately parallel in the lateral direction of the transverse section of the first tapered part of the tapered part.

3. The flow cytometer of claim 1, wherein
the transverse section of the second flow pass at the outlet of the tapered part is circular.

4. The flow cytometer of claim 1, wherein
the first flow pass has an aspect ratio larger than on the transverse section;
the lateral direction of the transverse section of the first tapered part of the second flow pass and the longitudinal direction of the transverse section of the first flow pass are approximately parallel.

5. The flow cytometer of claim 2, wherein
the two inclined surface parts at the downstream end of the sample nozzle are flat surfaces.

6. The flow cytometer of claim 1, wherein
the aspect ratio is 1.2 or larger on the transverse section of the flow pass at the position of the downstream end of the sample nozzle at the first tapered part.

7. The flow cytometer of claim 1, wherein
the shape of the transverse section of the flow pass at the position of the downstream end of the sample nozzle at the first tapered part is respectively symmetrical on the centerline in the longitudinal and lateral directions.

8. The flow cytometer of claim 7, wherein
the shape of the transverse section of the flow pass at the position of the downstream end of the sample nozzle at the first tapered part is elliptical, oval, or rectangular.

9. The flow cytometer of claim 1, wherein
the tapered part has an approximately conical second tapered part, and
the first tapered part is formed to be continuous from the midsection of the conical second tapered part.

10. The flow cytometer of claim 9, wherein
the first tapered part has a first part with a transverse section shaped so as to connect a part of the transverse section of the first tapered part and a part of the transverse section of the second tapered part, and has a second part with a transverse section shaped so as to consist of the transverse section of the first tapered part at the downstream side of the first part;
the tapered part is formed so that the second tapered part, first part of the first tapered part, and the second part are smoothly continuous.

11. The flow cytometer of claim 3, further comprising:
a connecting flow pass of approximate conical shape in which the flow pass narrows toward the first flow pass, and connects the first flow pass to the outlet of the tapered part of the second flow pass.

12. The flow cytometer of claim , further comprising:
an imaging section for imaging the measurement object flowing through the first flow pass of the flow cell from a direction parallel to the longitudinal direction of the transverse section of the first tapered part of the tapered part.

13. The flow cytometer of claim , further comprising:
a scattered light detection section for detecting the forward scattered light from the measurement object flowing through the first flow pass of the flow cell from a direction perpendicular to the longitudinal direction of the transverse section of the first tapered part of the tapered part.

14. The flow cytometer of claim , further comprising:
a fluorescent light detection section for detecting the fluorescent light from the measurement object flowing through the first flow pass of the flow cell from a direction parallel to the longitudinal direction of the transverse section of the first tapered part of the tapered part.

15. The flow cytometer of claim 1, wherein
the measurement object has an asymmetrical flat shape.

16. The flow cytometer of claim 1, wherein
the measurement object is a squamous cell.

17. An analyzer, comprising:
a detection section for detecting a measurement object in a measurement sample; and
a controller configured for performing operations, comprising: outputting based on the detection result of the detection section; wherein
the detection section comprises
a flow cytometer, comprising:
a sample nozzle for passing a measurement sample containing a measurement object;
a flow cell with an interior first flow pass, the flow cell being arranged downstream from the sample nozzle;
a sample nozzle receiving section with an interior second flow pass that communicates with the first flow pass and has a larger internal diameter than the exterior diameter of the sample nozzle, configured to hold the sample nozzle within the second flow pass;
a measurement sample supplying section for supplying a measurement sample to the sample nozzle; and
a sheath fluid supplying section for supplying sheath fluid to the second flow pass of the sample nozzle receiving section; wherein
the sample nozzle receiving section comprises at least in part a tapered part for narrowing the second flow pass toward the first flow pass;
the tapered part has a first tapered part with an aspect ratio larger than 1 of the transverse section of the flow pass intersecting the flow direction of the measurement sample; and
the end on the downstream side of the sample nozzle is arranged at the first tapered part of the tapered part.

18. The flow cytometer of claim 17, further comprising:
an imaging section for imaging the measurement object flowing through the first flow pass of the flow cell from a direction parallel to the longitudinal direction of the transverse section of the first tapered part of the tapered part.

19. The flow cytometer of claim 17, further comprising:
a scattered light detection section for detecting the forward scattered light from the measurement object flowing through the first flow pass of the flow cell from a direction perpendicular to the longitudinal direction of the transverse section of the first tapered part of the tapered part.

20. The flow cytometer of claim 17, further comprising:
a fluorescent light detection section for detecting the fluorescent light from the measurement object flowing through the first flow pass of the flow cell from a direction parallel to the longitudinal direction of the transverse section of the first tapered part of the tapered part.
